(19) United States
(12) Patent Application Publication
(10) Pub. No.: US 2014/0125292 A1
(43) Pub. Date: May 8, 2014

(54) LITHIUM ENERGY STORAGE DEVICE

(71) Applicants: MONASH UNIVERSITY, CLAYTON (AU); COMMONWEALTH SCIENTIFIC AND INDUSTRIAL RESEARCH ORGANISATION, CAMPBELL (AU)

(72) Inventors: Adam Samuel Best, Ferntree Gully (AU); George Hamilton Lane, Clayton (AU)

(73) Assignees: MONASH UNIVERSITY, CLAYTON (AU); COMMONWEALTH SCIENTIFIC AND INDUSTRIAL RESEARCH ORGANISATION, CAMPBELL (AU)

(21) Appl. No.: 14/064,395

(22) Filed: Oct. 28, 2013

Related U.S. Application Data
(63) Continuation of application No. PCT/AU2012/000442, filed on Apr. 27, 2012.

(30) Foreign Application Priority Data
Apr. 27, 2011 (AU) 2011901573

(51) Int. Cl. H01M 10/0568; H02J 7/00; H01G 11/06; H01M 10/0525

(52) U.S. Cl. CPC H01M 10/0568; H01M 10/0525; H02J 7/00; H01G 11/06
USPC 320/137; 429/188; 429/199; 429/200; 361/502

(57) ABSTRACT

The present invention generally relates to lithium based energy storage devices. According to the present invention there is provided a lithium energy storage device comprising: at least one positive electrode; at least one negative electrode; and an ionic liquid electrolyte comprising an anion, a cation counterion and lithium mobile ions, wherein the anion comprises a nitrogen, boron, phosphorous, arsenic or carbon anionic group having at least one nitrile group coordinated to the nitrogen, boron, phosphorous, arsenic or carbon atom of the anionic group.

### PRIOR RELATED APPLICATIONS

This application is a continuation application of PCT Patent Application No. PCT/AU2012/000442 filed Apr. 27, 2012, which claims the benefit of Australian Application No. 2011901573 filed Apr. 27, 2011, which is incorporated herein by reference in its entirety.

### FIELD

The present invention relates to lithium based energy storage devices.

### BACKGROUND

There have been ongoing developments with electrolytes used in energy storage devices, such as electrolytes for use in lithium ion and lithium metal batteries.

Electrochemical based energy storage devices typically contain electrolytes within which charge carriers (either ions, also referred to as target ions, or other charge carrying species) can move to enable the function of the given device. There are many different types of electrolytes available for use in electrochemical devices. In the case of lithium ion and lithium metal batteries, these include gel electrolytes, polyelectrolytes, gel polyelectrolytes, ionic liquids, plastic crystals and other non-aqueous liquids, such as ethylene carbonate, propylene carbonate and diethyl carbonate.

Ideally, the electrolytes used in these devices are required to be electrochemically stable, have high ionic conductivity, a high target ion transport number (i.e. high mobility of the target ion compared to that of other charge carriers), and provide a stable electrolyte-electrode interface which allows charge transfer. The electrolytes should ideally also be thermally stable, and non-flammable.

Lithium batteries may be primary or, more typically, secondary (rechargeable) batteries. Lithium rechargeable batteries offer advantages over other secondary battery technologies due to their higher gravimetric and volumetric capacities as well as higher specific energy.

The two classes of lithium batteries mentioned above differ in that the negative electrode is lithium metal for ‘lithium metal batteries’, and is a lithium intercalation material for the ‘lithium-ion batteries’.

In terms of specific energy and power, lithium metal is the preferred negative electrode material. However, when ‘traditional’ solvents are used in combination with lithium metal negative electrodes, there is a tendency for the lithium metal electrode to develop a dendritic surface. The dendritic deposits limit cycle life and present a safety hazard due to their ability to short circuit the cell—potentially resulting in fire and explosion. These shortcomings have necessitated the use of lithium intercalation materials as negative electrodes (creating the well-known lithium-ion technology), at the cost of additional mass and volume for the battery.

In lithium metal secondary cells, a solid electrolyte interphase (SEI) is formed on the lithium electrode surface. The SEI is a passivation layer that forms rapidly because of the reactive nature of lithium metal. The SEI has a dual role. Firstly, it forms a passivating film that protects the lithium surface from further reaction with the electrolyte and/or contaminants. In addition, the SEI acts as a lithium conductor that allows the passage of charge, as lithium ions, to and from the lithium surface during the charge/discharge cycling of a lithium metal secondary cell. The SEI is also known to form on the surface of a negative electrode in lithium ion cells. However, the SEI if present can be a resistive component for some cell systems and can lead to a reduced cell voltage (and hence cell power).

Researchers have continued to search for a solution to the poor cycling characteristics of the lithium metal electrode—notably through the use of polymer electrolytes. However lithium ion motion in polymer electrolytes is mediated by segmental motions of the polymer chain leading to relatively low conductivity. The low conductivity and low mobility of the polymer electrolytes has restricted their application in practical devices.

Such problems of low conductivity and low transport number of the target ion apply similarly to other electrolytes used in lithium metal batteries, lithium-ion batteries, batteries more generally, and to an extent all other electrochemical devices.

Consequently, there is a need to identify new electrolytes for lithium energy storage devices that allow improved performance.

### SUMMARY

According to the present invention there is provided a lithium energy storage device comprising:
at least one positive electrode;
at least one negative electrode; and
an ionic liquid electrolyte comprising an anion, a cation counterion and lithium mobile ions, wherein the anion comprises a nitrogen, boron, phosphorous, arsenic or carbon anionic group having at least one nitrile group coordinated to the nitrogen, boron, phosphorous, arsenic or carbon atom of the anionic group.

The anion may be an anion of Formula Ito IV:

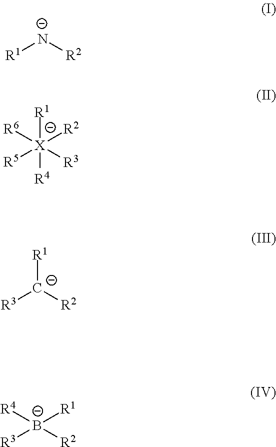

wherein

X is P or As;

R¹ is CN;

R², R³, R⁴, R⁵ and R⁶ are each independently an organic group.

The organic group may comprise an electron withdrawing group, such as a group capable of stabilising a negative charge of an anion, for example a halogen, oxalate, tosylate, ether, ester, nitrile, sulphonyl, carbonyl or nitro group.

The organic group may be independently selected from the group consisting of —CN, —F, —Cl, —(COO)₂⁻, CₘY₂ₘ₊₁SO₂—, CₘY₂ₘ₊₁SO₃—, CₘY₂ₘ₊₁C₆Y₄SO₂—, CₘY₂ₘ₊₁C₆Y₄SO₃—, R⁷—SO₂—, R⁷—SO₃—, CₘY₂ₘ₊₁C(O)O—, CₘY₂ₘ₊₁O(O)C—, CₘY₂ₘ₊₁CY₂O, CY₃O—, CₘY₂ₘ₊₁OCY₂—, —C₂₋₆alkenyl; wherein Y is F or H, m is an integer of 1 to 6, and R⁷ is a halogen.

The organic group may be —CN. For example, the anion may be selected from the group consisting of ⁻P(CN)₆, ⁻As(CN)₆, ⁻N(CN)₂, ⁻C(CN)₃ and ⁻B(CN)₄.

The anion may be ⁻N(CN)₂, namely dicyanamide.

The ionic liquid electrolyte may be substantially free of halide ions. The ionic liquid electrolyte may be substantially free of fluoride ions.

The lithium mobile ions may be provided by one or more lithium salts selected from the group consisting of LiDCA, LiBF₄, LiBOB, LiTFSI, LiFSI, and LiPF₆.

The lithium mobile ions may be introduced as a salt, and may be referred to as a dopant. The level of lithium salt doping may be between about 0.1 to 2 mol/kg, 0.2 to 1.5 mol/kg, or 0.5 to 1 mol/kg.

The cation counterion may be selected from the group consisting of pyrrolidiniums, piperaziniums, piperidiniums, di- or tri-substituted imidazoliums and the phosphorous and arsenic derivatives thereof. The cation counterion may be pyrrolidinium. The cation counterion may be a 1,1-dialkyl-pyrrolidinium, for example N-butyl-N-methyl-pyrrolidinium.

The at least one positive electrode may comprise a lithium oxide material selected from the group consisting of LiCoO₂, LiMnO₂, LiMn₂O₄, LiMnO₂, LiNiMnCrO₂, LiMnNiO₄, and analogues thereof, conducting polymers, redox conducting polymers, and combinations thereof.

The at least one positive electrode may comprise a lithium metal phosphate in which the metal is a first-row transition metal, or a doped derivative thereof. The at least one positive electrode may comprise a lithium iron phosphate. The lithium iron phosphate may be LiFePO₄.

The at least one positive electrode or the at least one negative electrode may comprise a lithium titanium oxide material. For example, the lithium titanium oxide material may be Li₄Ti₅O₁₂.

The at least one negative electrode may be a lithium metal negative electrode.

The ionic liquid electrolyte may comprise a solid electrolyte interphase (SEI) forming additive. The SEI forming additive may be a carbonate such as ethylene carbonate. Vinylene carbonate may be unstable in DCA based ionic liquids. The SEI forming additive may be a glyme, such as tetraglyme.

The ionic liquid electrolyte may comprise a small amount of water. For example, the ionic liquid electrolyte may comprise water at an amount of less than 1000 ppm, less than 750 ppm, less than 500 ppm, less than 250 ppm, or in a range of 50 to 500 ppm, in a range of 75 to 250 ppm, or in a range of 100 to 200 ppm. The amount of water may be in the range of 100 and 300 ppm, or about 200 ppm.

The lithium energy storage device may be a lithium metal energy storage device. The lithium energy storage device may be a lithium ion energy storage device.

The lithium energy storage device may be operable over a temperature range of −30 to 200° C., −20 to 150° C., −10 to 100° C., or 0 to 80° C.

The lithium energy storage device may be a lithium metal energy storage device comprising:
at least one positive electrode;
at least one lithium metal negative electrode; and
an ionic liquid electrolyte comprising a dicyanamide anion, a cation counterion and lithium mobile ions.

The lithium energy storage device may be a lithium metal energy storage device comprising:
at least one positive electrode comprising lithium iron phosphate;
at least one lithium metal negative electrode; and
an ionic liquid electrolyte comprising a dicyanamide anion, a cation counterion and lithium mobile ions.

The lithium energy storage device may be a lithium ion energy storage device comprising:
at least one positive electrode comprising lithium iron phosphate;
at least one negative electrode comprising lithium titanium oxide; and
an ionic liquid electrolyte comprising a dicyanamide anion, a cation counterion and lithium mobile ions.

The lithium titanium oxide material may be LiTi₅O₁₂. The lithium iron phosphate may be LiFePO₄.

The lithium energy storage device may also comprise a case for containing the electrodes and electrolyte, and electrical terminals for connection to equipment to be powered by the energy storage device. The device may also comprise separators located between the adjacent positive and negative electrodes.

According to the present invention there is provided a use of the ionic liquid electrolyte as herein described, in a lithium energy storage device.

According to the present invention, there is also provided a use of ionic liquid comprising a dicyanamide anion, a cation counterion and lithium mobile ions as an electrolyte in a lithium energy storage device. Also provided is the use of lithium iron phosphate as a positive electrode active material in a lithium energy storage device. Further provided is the use of lithium titanium oxide as a negative electrode active material in a lithium energy storage device.

According to the present invention there is provided a method of charging the lithium energy storage device as herein described, comprising the step of charging the device at a charge voltage of less than 3.8 V. The charge voltage may be at or less than 3.6 V.

### BRIEF DESCRIPTION OF THE FIGURES

Embodiments of the present invention are further described and illustrated below, by way of example only, with reference to the accompanying drawings in which:

FIG. 1 shows a lithium energy storage device according to one embodiment of the present invention;

FIG. 2 shows the electrochemical window of the neat ionic liquids (top) C₄C₁pyr DCA, C₄C₁pyr TCM, C₄C₁pyr TCB and (bottom) C₄C₁pyr TFSI as a reference, with each electrode scanned in both the forward and reverse directions as indicated by the arrows;

FIG. 3 is an FTIR graph showing the association of lithium ions with a dicyanamide anion at various concentrations of the lithium ion;

FIG. 4 is a diagram showing cyclic voltammograms for the electrolyte C₄C₁pyr DCA+0.5 mol/kg LiDCA 132 ppm H₂O, scan 1 (solid line), scan 3 (shaded line) and scan 3 (dotted line);

FIG. 5 is a diagram showing cyclic voltammograms for the electrolyte C₄C₁pyr DCA+0.5 mol/kg LiDCA 285 ppm H₂O, scan 1 (solid line), scan 3 (shaded line) and scan 3 (dotted line);

FIG. 6 is a graph showing C₄C₁pyr DCA+0.5 mol.kg⁻¹ Li DCA with various concentrations of moisture in solution and the peak currents for the stripping of lithium from the electrode (open circles) and peak currents for plating of lithium on the electrode (filled squares), and conducted on a Pt working electrode;

FIG. 7 is a diagram showing cyclic voltammograms for the electrolyte C₄C₁pyr DCA+0.5 mol/kg LiBF₄ 296 ppm H₂O, scan 1 (solid line), scan 3 (shaded line) and scan 3 (dotted line);

FIG. 8 is a graph showing the specific capacity vs cycle number for LFP|Li cells cycled at 50° C. with different charging cut off voltages, the electrolyte is C₄C₁pyr DCA+0.5 mol/kg LiDCA, charge capacity using 3.8 V limit (filled squares), discharge capacity using 3.8 V limit (open squares), cycling efficiency using 3.8 V limit (open diamonds), charge capacity using 3.6 V limit (filled circles), discharge capacity using 3.6 V limit (open circles), cycling efficiency using 3.6 V limit (filled diamonds);

FIG. 9 is Scanning Electron Micrograph (SEM) showing the cross-sectional view of a lithium anode having being cycled 100 times in C₄C₁pyr DCA+0.5 mol/kg LiDCA, with the SEI region and the bulk lithium metal electrode (below) shown;

FIG. 10 is a graph showing the specific capacity vs cycle number for LFP|Li cells cycled at 50° C. with the electrolyte C₄C₁pyr DCA+0.5 mol/kg LiDCA or C₄C₁pyr DCA (80 mol/mol %) tetraglyme (20 mol/mol %)+0.5 mol/kg LiDCA, charge capacity without tetraglyme (filled squares), discharge capacity without tetraglyme (open squares), cycling efficiency without tetraglyme (open diamonds), charge capacity with tetraglyme (filled circles), discharge capacity with tetraglyme (open circles), cycling efficiency with tetraglyme (filled diamonds);

FIG. 11 is a graph showing the specific capacity vs cycle number for LFP|Li cell cycled at 50° C. with the electrolyte C₄C₁pyr DCA+0.45 mol/kg LiDCA+0.05 mol/kg LiBOB, charge capacity (filled squares), discharge capacity (open squares) and cycling efficiency (filled diamonds);

FIG. 12 is a graph showing the specific capacity vs cycle number for LTO|Li cell cycled at 50° C. with the electrolyte C₄C₁pyr DCA+0.5 mol/kg LiDCA, charge capacity (filled squares), discharge capacity (open squares) and cycling efficiency (filled diamonds);

FIG. 13 is a graph showing the specific capacity vs cycle number for LFP|LTO cell cycled at 50° C. with the electrolyte C₄C₁pyr DCA+0.5 mol/kg LiDCA, charge capacity (filled squares), discharge capacity (open squares) and cycling efficiency (filled diamonds);

FIG. 14 is a graph showing the specific discharge capacity vs discharge current density for a LFP|Li cell cycled at 50° C. with a charging current density of 0.05 mA/cm² and different discharge current densities; and

FIG. 15 is a graph showing the specific discharge capacity vs discharge current density for a LFP|Li cell cycled at 50° C. with a discharging current density of 0.05 mA/cm² and different charging current densities.

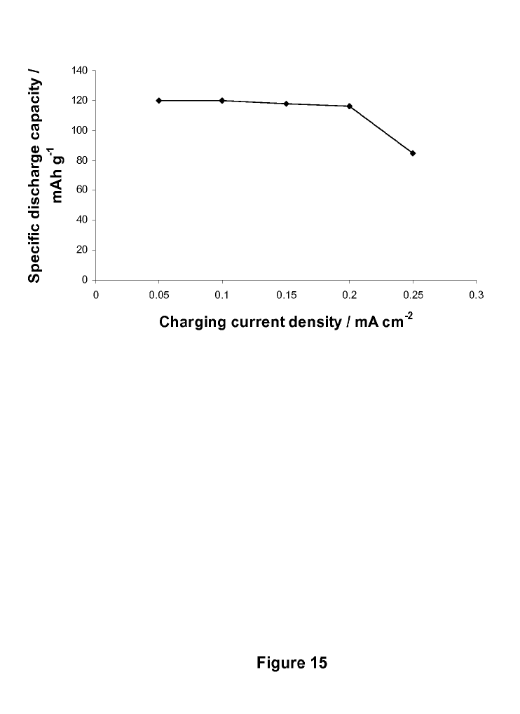

### DESCRIPTION OF THE ABBREVIATIONS

In the Examples and embodiments of the present invention detailed below, reference will be made to the following abbreviations in which:

### C Celsius

### Cl Class

### DCA Dicyanamide

### [ ] Concentration

FSI Lithium bis(fluorosulfonyl)imide

### FTIR Fourier Transform Infrared Spectroscopy

### h Hour

HRPSoC High rate partial state-of-charge
LFP Lithium iron phosphate
LiBF₄ Lithium tetrafluoroborane
LiBOB Lithium bis(oxalato)borate
LiDCA Lithium dicyanamide
LiFSI Lithium bis(fluorosulphonylimide)
LiPF₆ Lithium hexafluorophosphate
LiTFSI Lithium bis(trifluoromethanesulfonyl)imide
LMP Lithium metal phosphate
LTO Lithium titanium oxide
Mn Number average molecular weight
Mw Weight average molecular weight
MW Molecular weight
PSoC Partial state-of-charge conditions

### RH Relative Humidity

SG Specific gravity or relative density with respect to water

### SEM Scanning Electron Microscopy

### TCM Tetracyanomethanide

### TCB Tetracyanoborate

Wt % Weight percentage of specific component in composition

### XPS X-Ray Photoelectron Spectroscopy

### DETAILED DESCRIPTION

In an attempt to identify alternative materials that are useful as ionic liquid electrolytes in lithium energy storage devices, it has now been found that an ionic liquid electrolyte comprising an anion with one or more coordinated nitrile groups may be effective for use in such devices. The non-limiting particular embodiments of the present invention are described as follows.

The term “energy storage device” broadly encompasses all devices that store or hold electrical energy, and encompasses batteries, supercapacitors and asymmetric (hybrid) battery-supercapacitors. The term battery encompasses single cells.

Lithium-based energy storage devices are those devices that contain lithium ions in the electrolyte, such as lithium batteries.

The term lithium battery encompasses both lithium ion batteries and lithium metal batteries.

Lithium ion batteries and lithium metal batteries are well known and understood devices, the typical and general components of which are well known in the art.

Secondary lithium batteries are lithium batteries which are rechargeable. The lithium energy storage devices of the present invention may be secondary lithium batteries. In secondary batteries the combination of the electrolyte and negative electrode of such batteries must be such as to enable both plating/alloying (or intercalation) of lithium onto the electrode (i.e. charging) and stripping/de-alloying (or de-intercalation) of lithium from the electrode (i.e. discharging). The electrolyte is required to have a high stability towards lithium, for instance approaching ˜0V vs. Li/Li⁺. The electrolyte cycle life is also required to be sufficiently good, for instance at least 100 cycles (for some applications), and for others, at least 1000 cycles.

### Secondary Lithium Batteries

The general components of a secondary lithium battery are well known and understood in the art of the invention. The principal components are:
a battery case, of any suitable shape, standard or otherwise, which is made from an appropriate material for containing the electrolyte, such as aluminium or steel, and usually not plastic;
battery terminals of a typical configuration;
at least one negative electrode;
at least one positive electrode;
optionally, a separator for separating the negative electrode from the positive electrode; and
an electrolyte containing lithium mobile ions.

### Electrolyte

The electrolyte is an ionic liquid comprising an anion and a cation counterion. Ionic liquids, which are sometimes referred to as room temperature ionic liquids, are organic ionic salts having a melting point below the boiling point of water (100° C.). It will also be understood that for lithium energy storage devices according to the present invention, the electrolyte will include lithium mobile ions.

According to the present invention, the anion may comprise a nitrogen, boron, phosphorous, arsenic or carbon anionic group having at least one nitrile group coordinated to the nitrogen, boron, phosphorous, arsenic or carbon atom of the anionic group. The nitrile group, also commonly known as a cyano group, is an electron withdrawing organic moiety having the structural formula —C≡N.

The anion may be an anion of Formula Ito IV:

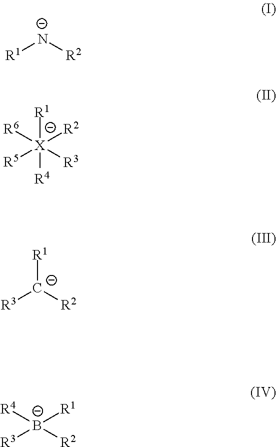

wherein

X is P or As;

R¹ is CN;

R², R³, R⁴, R⁵ and R⁶ are each independently an organic group.

The organic group may comprise an electron withdrawing group, such as a group capable of stabilising a negative charge of an anion, for example a halogen, oxalate, ether, ester, nitrile, sulphonyl, sulphonamide, carbonyl or nitro group.

The organic group may be independently selected from the group consisting of —CN, —F, —Cl, —(COO)₂⁻, CₘY₂ₘ₊₁SO₂—, CₘY₂ₘ₊₁SO₃—, CₘY₂ₘ₊₁C₆Y₄SO₂—, CₘY₂ₘ₊₁C₆Y₄SO₃—, R⁷—SO₂—, R⁷SO₃—, CₘY₂ₘ₊₁C(O)O—, CₘY₂ₘ₊₁O(O)C—, CₘY₂ₘ₊₁CY₂O, CY₃O—, CₘY₂ₘ₊₁OCY₂—, —C₂₋₆alkenyl; wherein Y is F or H, m is an integer of 1 to 6, and R⁷ is a halogen.

The organic group may be independently selected from the group consisting of —C₁₋₆alkyl, —C₂₋₆alkenyl, C₀₋₆alkylphenyl-, optionally interrupted with, terminated by or connected via one or more groups selected from —C(O)O—, —O—, —SO₂—, —SO₃—.

C₁₋₆alkyl and C₂₋₆alkenyl include a straight, branched or cyclo chain, or combination thereof. C₂₋₆alkenyl may be an alkyl vinyl group, for example an allyl group. CₘY₂ₘ₊₁C₆Y₄SO₂— may be CH₃C₆H₄SO₂—.

The organic group may be —CN. For example, the anion may selected from the group consisting of ⁻P(CN)₆, ⁻As(CN)₆, ⁻N(CN)₂, ⁻C(CN)₃ and ⁻B(CN)₄.

The anion may be ⁻N(CN)₂, namely dicyanamide.

The anion, or organic group thereof, may comprise a cyano-group other than dicyanamide.

The organic group may be selected from —CN and —F. For example, the anion may be ⁻PF(CN)₅, ⁻AsF(CN)₅, ⁻AsF₂(CN)₄, ⁻NF(CN), ⁻CF₂(CN) and ⁻BF₂(CN)₂.

The organic groups are selected to keep the molecular weight of the anion as low as possible.

The anion may be symmetric or asymmetric.

It has been found that using an organic anion selected from a boron, carbon, phosphorous, arsenic or nitrogen anion comprising at least one coordinated cyano moiety, as an ionic liquid electrolyte for a lithium energy storage device, unexpectedly allows lithium plating and stripping, gives good conductivity, viscosity and lithium-ion diffusivities, and reduces the rate of dendrite formation.

The ionic liquid electrolyte may be substantially free of halide ions. For example, the ionic liquid electrolyte may be substantially free of fluoride ions. An ionic liquid electrolyte containing an anion comprising a nitrogen, boron, phosphorous, arsenic or carbon anionic group having at least one nitrile group coordinated to the nitrogen, boron, phosphorous, arsenic or carbon atom of the anionic group, has been found to be effective for use with a lithium energy storage device without the need for a source of halide ions, for example fluoride ions. A halide (e.g. fluoride) free electrolyte is advantageous since appropriate sources of such ions can be relatively expensive. Consequently, a fluoride free electrolyte typically engenders lower manufacturing costs compared to other low viscosity ionic liquids which contain fluoride ions. Other advantages of a halide free electrolyte, such as a chloride free electrolyte, may include beneficial effects for cycling performance.

The term “substantially free” in relation to halide ions (e.g. fluoride ions) generally refers to an ionic liquid that avoids the presence of halide ions. Ideally, the content of halide ions (or fluoride ions) is zero but it will be appreciated that minor contamination may occur at an industrial scale of production, and particularly sensitive instruments may be able to measure background or trace amounts of any element. Therefore, “substantially free” may refer to a content that is less than 0.15 wt %, less than 0.1 wt %, less than 0.01 wt %, or less than 0.001 wt %, based on the total weight of the ionic liquid. In one embodiment, the ionic liquid is completely free of halide ions.

The ionic liquid electrolyte may comprise a small amount of water. For example, the ionic liquid electrolyte may comprise water at an amount of less than 1000 ppm, less than 750 ppm, less than 500 ppm, less than 250 ppm, or in a range of 50 to 500 ppm, in a range of 75 to 250 ppm, or in a range of 100 to 200 ppm. The amount of water may be in the range of 100 to 300 ppm, or about 200 ppm. An advantage of the ionic liquid electrolytes being effective for use with lithium energy storage devices while still containing small amounts of water is that the manufacturing costs of these devices are lowered since the electrolytes and components thereof do not require extensive drying and removal of water.

The cation counterion may be any of the cations known for use as components of ionic liquids. The cation may be an unsaturated heterocyclic cation, a saturated heterocyclic cation or a non-cyclic quaternary cation.

The unsaturated heterocyclic cations encompass the substituted and unsubstituted pyridiniums, pyridaziniums, pyrimidiniums, pyraziniums, imidazoliums, pyrazoliums, thiazoliums, oxazoliums and triazoliums, two-ring system equivalents thereof (such as isoindoliniums) and so forth. The general class of unsaturated heterocyclic cations may be divided into a first subgroup encompassing pyridiniums, pyridaziniums, pyrimidiniums, pyraziniums, pyrazoliums, thiazoliums, oxazoliums, triazoliums, and multi-ring (i.e., two or more ring-containing) unsaturated heterocyclic ring systems such as the isoindoliniums, on the one hand, and a second subgroup encompassing imidazoliums, on the other.

Two examples of this general class are represented below:

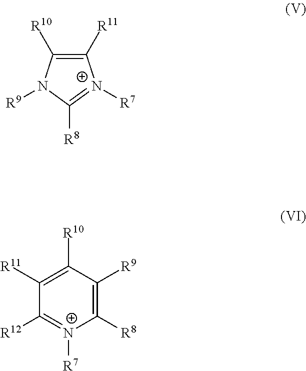

wherein:

R⁷ to R¹² are each independently selected from H, alkyl, haloalkyl, thio, alkylthio and haloalkylthio.

The saturated heterocyclic cations encompass the pyrrolidiniums, piperaziniums, piperidiniums, and the phosphorous and arsenic derivatives thereof.

Examples of these are represented below:

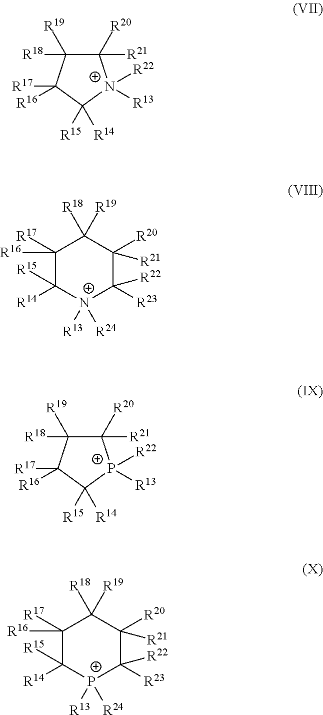

wherein:

R¹³ to R²⁴ are each independently selected from H, alkyl, haloalkyl, thio, alkylthio and haloalkylthio.

The non-cyclic quaternary cations encompass the quaternary ammonium, phosphonium and arsenic derivatives.

Examples of these are represented below:

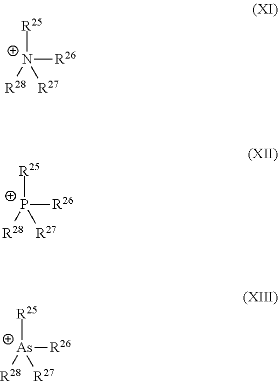

wherein:

R₂₅ to R₂₈ are each independently selected from H, alkyl, haloalkyl, thio, alkylthio and haloalkylthio.

The term “alkyl” is used in its broadest sense to refer to any straight chain, branched or cyclic alkyl groups of from 1 to 20 carbon atoms in length. For example, the alkyl group may be straight chained and comprise a group from 1 to 10 atoms in length. For example, the term may comprise a group selected from methyl, ethyl, propyl, butyl, pentyl, hexyl, heptyl, octyl, nonyl, and decyl. It will be understood that the term “diakyl” refers to two independent “alkyl” groups.

Halogen, halo, the abbreviation “Hal” and like terms refer to fluoro, chloro, bromo and iodo, or the “halide” anions as the case may be.

The cation counterion may be selected from the group consisting of pyrrolidiniums, piperaziniums, piperidiniums, and the phosphorous and arsenic derivatives thereof. For example, the cation counterion may be pyrrolidinium.

Of the possible counterions for the electrolyte, the 1,1-dialkyl pyrrolidinium are preferred. For example, the 1,1-dialkyl pyrrolidiniums include N-methyl-N-propyl-pyrrolidinium and N-butyl-N-methyl-pyrrolidinium.

For ease of reference in the Figures and Examples, N-butyl-N-methyl-pyrrolidinium is referred to as “C₄C₁pyr”. It will be understood that in the abbreviated term, “pyr” refers to pyrrolidinium and the numerals in subscript with “C” refer to the alkyl chain length for the substituents on the nitrogen atom of the pyrrolidinium ring system.

Mobile Lithium ions

The ionic liquid electrolyte contains lithium mobile ions, which are typically introduced as a salt, and otherwise known as a dopant. The level of lithium salt doping may be between about 0.1 to 2 mol/kg, 0.2 to 1.5 mol/kg, 0.3 to 1.2 mol/kg, or about 5 mol/kg. The level of lithium salt doping is typically less than 1.0 mol/kg, and may be less than 0.7 mol/kg, less than 0.5 mol/kg, less than 0.3 mol/kg, less than 0.2 mol/kg, or less than 0.1 mol/kg. The level of lithium salt doping may be greater than 0.1 mol/kg, greater than 0.3 mol/kg, or greater than 0.5 mol/kg. In one embodiment, the level of lithium salt doping may be in the range of 0.2 to 0.8 mol/kg, 0.3 to 0.7 mol/kg, or 0.4 to 0.6 mol/kg. In another particular embodiment, the level of lithium salt doping may be about 0.5 mol/kg.

The lithium mobile ions may be provided by one or more lithium salts selected from the group consisting of LiDCA, LiBF₄, LiBOB, LiTFSI, LiFSI, and LiPF₆. The lithium salt may include a single anionic group, such as dicyanamide, or a combination of two or more anionic groups, such as dicyanamide with BF₄ and/or BOB.

Unexpectedly, the lithium salt of LiBF₄ provides excellent conductivity, low viscosity, high lithium ion diffusivity and allows lithium plating and stripping to occur at higher current densities than other electrolytes systems with different lithium salts. This combination is also advantageous in a device due to the lower molecular weight of the electrolyte increasing the energy density of the cell.

The lithium salt may also be selected from one or more of:
(i) bis(alkylsulfonyl)imides, and perfluorinated bis(alkylsulfonyl)imides such as bis(trifluoromethylsulfonyl)imide (the term “amide” instead of “imide” is sometimes used in the scientific literature) or another of the sulfonyl imides. This includes (CH3SO2)2N⁻, (CF3SO2)2N⁻ (also abbreviated to Tf₂N) and (C₂F₅SO₂)₂N⁻ as examples. The bis imides within this group may be of the formula (CₓY₂ₓ₊₁SO₂)₂N— where x is an integer in the range of 1 to 6 and Y=F or H;
(ii) BF₄⁻ and perfluorinated alkyl fluorides of boron. Encompassed within the class are B(CₓF₂ₓ₊₁)ₐF₄₋ₐ⁻ where x is an integer in the range of 0 to 6, and a is an integer in the range of 0 to 4;
(iii) halides, alkyl halides or perhalogenated alkyl halides of group VA(15) elements. Encompassed within this class is E(CₓY₂ₓ₊₁)ₐ(Hal)₆₋ₐ⁻ where a is an integer in the range of 0 to 6, x is an integer in the range of 0 to 6, y is F or H, and E is P, As, Sb or Bi. Preferably E is P or Sb. Accordingly this class encompasses PF₆⁻, SbF₆⁻, P(C₂F₅)₃F₃⁻, Sb(C₂F₅)₃F₃⁻, P(C₂F₅)₄F₂⁻, AsF₆⁻, P(C₂H₅)₃F₃⁻ and so forth;
(iv) CₓY₂ₓ₊₁SO₃— where x is an integer in the range of 1 to 6 and Y=F or H. This class encompasses CH3SO3- and CF3SO3⁻ as examples;
(v) CₓF₂ₓ₊₁COO⁻, including CF3COO—;
(vi) sulfonyl and sulfonate compounds, namely anions containing the sulfonyl group SO₂, or sulfonate group SO₃⁻ not covered by groups (i) and (iv) above. This class encompasses aromatic sulfonates containing optionally substituted aromatic (aryl) groups, such as toluene sulfonate and xylene sulfonate;
(vii) cyanamide compounds and cyano group containing anions, including cyanide, dicyanamide and tricyanomethide;
(viii) succinamide and perfluorinated succinamide;
(ix) ethylendisulfonylamide and its perfluorinated analogue;
(x) SCN⁻;
(xi) carboxylic acid derivatives, including CₓH₂ₓ₊₁COO⁻ where x is an integer in the range of 1 to 6;
(xii) weak base anions;
(xiii) halide ions such as the iodide ion.

The electrolyte may comprise one or more further components, including one or more further room temperature ionic liquids, diluents, one or more solid electrolyte interphase-forming additives; one or more gelling additives; and organic solvents.

Solid electrolyte interphase (SEI)-forming additives improve the deposit morphology and efficiency of the lithium cycling process, and may also improve the transport properties of the bulk electrolyte. The gelling additives provide a gel material while retaining the conductivity of the liquid.

The SEI forming additive may be a carbonate such as ethylene carbonate. Vinylene carbonate may be unstable in DCA based ionic liquids.

SEI-forming additives may be selected from the group consisting of: polymers, including the electroconductive polymers, such as polyvinylpyrrolidone, polyethylene oxide, polyacrylonitrile, polyethylene glycols, the glymes, such as tetraglyme, perfluorinated polymers; and salts, such as magnesium iodide, aluminium iodide, tin iodide, lithium iodide, tetraethylammonium heptadecafluorooctanesulfonate, dilithiumpthalocyanine, lithium heptadecafluorooctanesulfonate, tetraethylammonium fluoride-tetrakis hydrogen fluoride.

The gelling additives may be selected from inorganic particulate materials (sometimes referred to as nanocomposites, being fine particulate inorganic composites). Amongst these, examples are SiO₂, TiO₂ and Al₂O₃.

### Negative Electrodes

The negative electrode typically comprises a current collector, which may be metal substrate, and a negative electrode material.

The negative electrode material can be lithium metal, a lithium alloy forming material, or a lithium intercalation material; lithium can be reduced onto/into any of these materials electrochemically in the device. Of particular interest are lithium metal, lithiated carbonaceous materials (such as lithiated graphites, activated carbons, hard carbons and the like), lithium intercalating metal oxide based materials such as lithium titanium oxides (e.g. Li₄Ti₅O₁₂), metal alloys such as Sn-based systems and conducting polymers, such as n-doped polymers, including polythiophene and derivatives thereof. For a description of suitable conducting polymers, reference is made to P. Novak, K. Muller, K. S. V. Santhanam, O. Haas, “Electrochemically active polymers for rechargeable batteries”, Chem. Rev., 1997, 97, 207-281, the entirety of which is incorporated by reference.

In the construction of an energy storage device, and particularly batteries, it is common for the negative electrode material to be deposited on the current collector during a formation stage. Accordingly, the references to the requirement of a negative electrode material in the negative electrode encompass the presence of a negative electrode-forming material (anode-forming material) in the electrolyte that will be deposited on the anode during a formation stage.

In the situation where a negative electrode material is applied to the current collector prior to construction of the energy storage device, this may be performed by preparing a paste of the negative electrode material (using typical additional paste components, such as binder, solvents and conductivity additives), and applying the paste to the current collector. Examples of suitable negative electrode material application techniques include one or more of the following:
(i) coating;
(ii) doctor-blading;
(iii) chemical polymerisation onto the surface, in the case of the conductive polymers;
(iv) printing, such as by ink-jet printing;
(v) electro-deposition (this technique may involve the inclusion of redox active materials or carbon nanotubes);
(vi) electro-spinning (this technique may involve the application of multiple layers, along with the inclusion of carbon nanotubes when applying a conductive polymer);
(vii) direct inclusion of the anode material in the polymer forming a synthetic fibre material-based fabric, through extrusion and/or electrospinning of the synthetic fibre;
(viii) vapour deposition and/or plasma reactor deposition.

It is noted that the negative electrode material may be applied in the form of the anode material itself, or in the form of two or more anode precursor materials that react in situ on the current collector. In this event, each anode precursor material can be applied separately by one or a combination of the above techniques.

The negative electrode surface may be formed either in situ or as a native film. The term “native film” is well understood in the art, and refers to a surface film that is formed on the electrode surface upon exposure to a controlled environment prior to contacting the electrolyte. The exact identity of the film will depend on the conditions under which it is formed, and the term encompasses these variations. The surface may alternatively be formed in situ, by reaction of the negative electrode surface with the electrolyte.

In addition to forming a native film on the lithium electrode, there may be physical changes in the micro-structure. Cycling these cells galvanostatically at high current densities (≧1 mA.cm⁻²), may result in a drop in the cells over-potential, a significant decrease in the impedance of the cell, or a decrease in the interfacial resistance (defined as the resistance between the electrode and the electrolyte) of the cell, which may be due to the formation of a highly conductive native film and/or a significant change in the surface area of the electrode.

### Current Collector

The current collector can be a metal substrate underlying the negative electrode material, and may be any suitable metal or alloy. It may for instance be formed from one or more of the metals Pt, Au, Ti, Al, W, Cu or Ni. In one embodiment the metal substrate is Cu or Ni. In another embodiment the metal substrate is Al.

### Positive Electrodes

According to various embodiments of the invention, the positive electrode material may be a lithium metal phosphate—LiMPO₄ or “LMP”.

An example of a lithium metal phosphate is lithium iron phosphate. It has been found that this combination of lithium metal phosphate as the positive electrode (cathode) material, with an ionic liquid electrolyte as described above provides a very robust device. Although different cathode materials may be used, this cathode material has been found to be unexpectedly resistant to the solvation properties of the ionic liquid, which for other cathodes can leach the transition metal ion out of the cathode material structure, resulting in structural damage and collapsing of the structure. Where a cathode other than lithium metal phosphate is used, such materials should be coated or protected with a nanolayer of a protective coating. Such a protective coating is not required for lithium metal phosphate—it is suitably protective coating-free. It is however noted that the lithium metal phosphate cathode can be coated with other types of coatings, such as conductive coatings which improve electrical conductivity of the active metals.

The metal of the lithium metal phosphate is a metal of the first row of transition metal compounds. These transition metals include Sc, Ti, V, Cr, Mn, Fe, Co, Ni and Cu. Iron (Fe) is preferred, and this compound (and doped versions thereof) are referred to as lithium iron phosphates—LiFePO₄ or LFP.

It is noted that the lithium metal phosphate may further comprise doping with other metals to enhance the electronic and ionic conductivity of the material. The dopant metal may also be of the first row of transition metal compounds.

The positive electrode material for the lithium energy storage device may be selected from any other suitable lithium battery positive electrode material. Of particular interest are other lithium intercalating metal oxide materials such as LiCoO₂, LiMnO₂, LiMn₂O₄, LiMnO₂, LiNiMnCrO₂, LiMnNiO₄, and analogues thereof, conducting polymers, redox conducting polymers, and combinations thereof. Conducting polymers may also be coated onto the lithium intercalating metal oxide/phosphate materials to enhance electrical conductivity to maintain capacity of the device and stabilise the lithium metal oxide/phosphate against dissolution by the ionic liquid electrolyte. Examples of lithium intercalating conducting polymers are polypyrrole, polyaniline, polyacetylene, polythiophene, and derivatives thereof. Examples of redox conducting polymers are diaminoanthroquinone, poly metal Schiff-base polymers and derivatives thereof. Further information on such conducting polymers can be found in the Chem. Rev. reference from above.

In the case of non-LMP positive electrode materials, these typically need to be coated with a protecting material, to be capable of withstanding the corrosive environment of the ionic liquid. This may be achieved by coating the electrochemically active material with a thin layer (typically 1-10 nanometer) of inert material to reduce the leaching of the transition metal ion from the metal oxide material. Suitable protecting material coatings include zirconium oxide, TiO₂, Al₂O₃, ZrO₂ and AlF₃.

Positive electrode materials are typically applied to the current collector prior to construction of the energy storage device. It is noted that the positive electrode or cathode material applied may be in a different state, such as a different redox state, to the active state in the battery, and be converted to an active state during a formation stage.

The positive electrode material is typically mixed with binder such as a polymeric binder, and any appropriate conductive additives such as graphite, before being applied to or formed into a current collector of appropriate shape. The current collector may be the same as the current collector for the negative electrode, or it may be different. Suitable methods for applying the positive electrode material (with the optional inclusion of additives such as binders, conductivity additives, solvents, and so forth) are as described above in the context of the negative electrode material.

### Other Device Features

When present, the separator may be of any type known in the art, including glass fibre separators and polymeric separators, particularly microporous polyolefins.

Usually the battery will be in the form of a single cell, although multiple cells are possible. The cell or cells may be in plate or spiral form, or any other form. The negative electrode and positive electrode are in electrical connection with the battery terminals.

### Charging and Conditioning of Device

A method of charging the lithium energy storage device as herein described, may comprise a step of charging the device at a charge voltage of less than 3.8 V. Preferably, the charge voltage is at or less than 3.6 V. The charge voltage may be at or less than 3.5 V, or at or less than 3.4 V. The charge voltage may be a charge cut off voltage. Improved performance may be achieved by using a lower charge or charge cut off voltage. Discharging of the device may also comprise a discharge cut off of 3.0 V.

The lithium energy storage device according to the present invention may be operable over a temperature range of −30 to 200° C., −20 to 150° C., a range of −10 to 100° C., a range of 0 to 80° C., or at a temperature of less than 150° C., less than 100° C., less than 80° C., less than 60° C., or about 50° C. It will be understood that the selection of suitable ionic liquid electrolytes may allow the device to operate in these temperature ranges.

### Interpretation

It is to be understood that, if any prior art publication is referred to herein, such reference does not constitute an admission that the publication forms a part of the common general knowledge in the art, in Australia or any other country.

It will be appreciated by persons skilled in the art that numerous variations and/or modifications may be made to the invention as shown in the specific embodiments without departing from the spirit or scope of the invention as broadly described. The above and below embodiments and examples are, therefore, to be considered in all respects as illustrative and not restrictive.

References to “a” or “an” should be interpreted broadly to encompass one or more of the feature specified. Thus, in the case of “an anode”, the device may include one or more anodes.

In this application, except where the context requires otherwise due to express language or necessary implication, the word “comprise” or variations such as “comprises” or “comprising” is used in an inclusive sense, i.e. to specify the presence of the stated features but not to preclude the presence or addition of further features.

### EXAMPLES

The present invention will now be described in further detail with reference to the following non-limiting Examples.

### Materials and Methods

### Battery Configuration

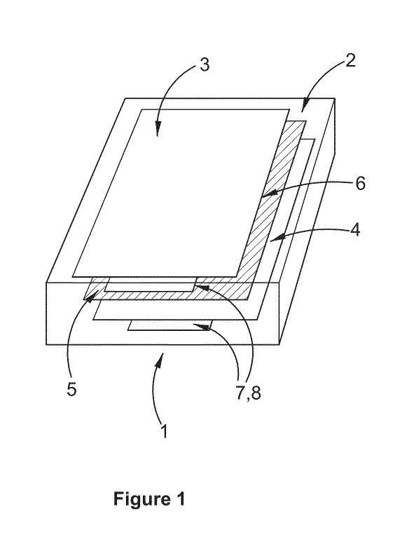

A secondary lithium battery (1) produced in accordance with the invention is shown schematically in FIG. 1. This battery comprises a case (2), at least one positive electrode (3) (one is shown), at least one negative electrode (4) (one is shown) an ionic liquid electrolyte (5) comprising an anion, a cation counterion and lithium mobile ions, a separator (6) and electrical terminals (7,8) extending from the case (2). The battery (1) illustrated is shown in plate-form, but it may be in any other form known in the art, such as spiral wound form.

### Electrolyte

Dicyanamide was used in all the examples as the anion component of the ionic liquid electrolyte. This anion has a relatively low molecular weight of 67.02 g/mol.

N-butyl-N-methyl-pyrrolidinium was used in all the examples as the cation component of the ionic liquid electrolyte. As mentioned above, for ease of reference in the Figures and Examples, N-butyl-N-methyl-pyrrolidinium cations are referred to as “C₄C₁pyr”. N-Butyl-N-methyl-pyrrolidinium dicyanamide has a relatively low viscosity (η=50 cP).

Concentrations were determined using electrochemistry, differential scanning calorimetry (DSC) viscosity and Nuclear Magnetic Resonance (NMR) measurements.

### Coin Cell and LMP Positive Electrode

Although it will be appreciated that other materials or methodologies could be used by those skilled in the art, a cell containing a positive electrode (cathode) of LiFePO₄ (LFP, Phostec, Canada) can be prepared as follows:

Slurry:
LFP and Shawinigan Carbon Black (CB) dried over a period of seven (7) days at 100° C.
In a 50 ml jar, with 3×12 mm and 12×5 mm Alumina spheres, LFP (4.0 g) and Shawinigan carbon black (0.8 g) are mixed together for 3-4 hours. This mix provides an approximate loading of between 2.1 to 3.1 mg.cm⁻² of active material on the current collector.
4.4 g of PVdF solution (12% PVdF dissolved in N-Methyl-Pyrrolidone NMP, Aldrich) is then added to the powder mixture so that the final percentage by weight of each component is 75:15:10 (LFP:CB:BINDER).
The slurry is then mixed overnight and added another 3 ml of NMP, mixed for another hour, added a further 1 ml NMP and further more mixed for another 1-2 hours until the correct consistency is achieved.

Coating:
Placed some of the slurry on the end of the sticky-pad where it meets the foil with a spatula and evenly distributed along the sticky-pad.
Using either 60 micron 100 micron or 150 micron rollers, roll down the aluminium foil with one steady stroke.
Let the coating dry under the fumehood to remove the excess solvent over two nights before storing the coatings in a bag.

### Example 1

### Preparation and Testing of Lithium Salts

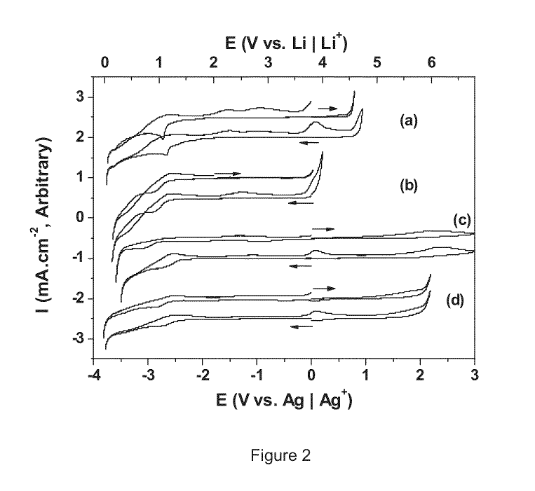

Initial experiments were conducted to determine the electrochemical window of the cyano-based anions described herein. FIG. 2 shows the electrochemical window for ionic liquids, without salt, which have the same cation namely N-butyl-N-methyl-pyrrolidinium. It can be observed that the ionic liquids with the cyano moieties have an inferior electrochemical window to the N—N-pyrrolidinium bis(trifluoromethansulfonyl)imide ionic liquid. Of all the cyano-based ionic liquids scanned here, a particularly advantageous system is the pyrrolidinium dicyanamide.

Experiments were conducted to identify if any lithium salts (i.e. dopants), which need to be dissolved into the ionic liquid electrolyte to provide a source of mobile lithium ions, could be effective for use with the above electrolyte comprising the dicyanamide anion.

The lithium salts of LiDCA, LiBF₄, LiBOB, LiTFSI, and LiFSI, were shown to be soluble at room temperature when provided in a concentration of less than 1.0 mol/kg, particularly at 0.5 mol/kg, in an electrolyte solution containing N-butyl-N-methyl-pyrrolidinium dicyanamide. It will be understood that “mol/kg” refers to moles of lithium ions per kilogram of electrolyte.

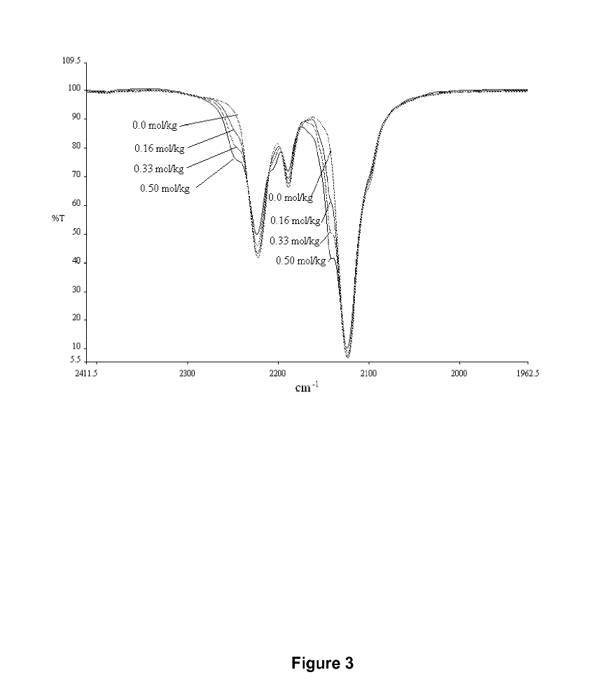

The interactions between lithium ions and dicyanamide anions were investigated by using FTIR. FIG. 3 is an FTIR graph showing that increasing concentrations of lithium ions, namely up to about 0.5 mol/kg, results in more prevalent interactions of Li⁺ with the dicyanamide anion; stabilising the anion as evidenced by the shift in the bands to higher frequency. This is supported by the work Brand et al., Chem Asia J., 4, 2009, pg 1588-1603.

It will be appreciated that if the electrolyte or lithium salt concentrations are too low then there may not be enough lithium ions or anions to provide an electrochemical window wide enough to (a) establish a stable solid electrolyte interface and (b) enough lithium-ions to plate. If ion concentrations are too high then plating and stripping of lithium ions will be adversely affected since the viscosity of the electrolyte increases together with a decrease in the conductivity and lithium ion diffusion. Typically, the concentrations of lithium salts need to be below 1 mol/kg. The concentration of lithium salts used in the examples was about 0.5 mol/kg.

Practical issues within lithium storage devices include polarisation of the electrodes, polarisation of the electrolyte, and resistances which can form within the device as a function of charge cycling. If these effects are minimised, the voltages observed are low. Where there are large resistances and polarisations, these voltages will be much higher. As the current densities used in the cell increases, the voltage response should remain unchanged.

### Example 2

### Testing of Electrolyte Consisting of C₄C₁pyr DCA 0.5 mol/kg LiDCA 132 ppm H₂O

Lithium cycling in the electrolyte was tested using cyclic voltammetry. The working electrode was a 500 micron diameter platinum disc electrode, polished with 0.05 micron alumina and dried prior to use. The counter electrode was platinum wire of surface area many times greater than the working electrode. The reference electrode consisted of a silver wire immersed in a solution of 10 mM silver triflate in N-butyl-N-methyl-pyrrolidinium bis(trifluoromethanesulfonyl)imide and separated from the main solution by a glass frit.

The working electrode was cycled from potentials 0 V (vs ref) to −4.3 V (vs ref) and back to 0 V (vs ref) for each scan. The scan rate was 50 mV/s and the experiment was performed at ambient temperature (˜23° C.) in an ultra high purity argon filled glove box.

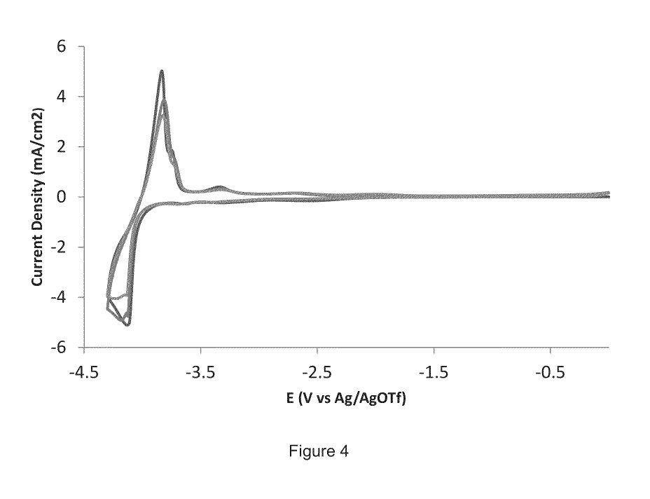

FIG. 4 shows the cyclic voltamograms for scans 1, 3 and 5. The main Li⁺ reduction peak begins at −3.9 V on the forward scan, stripping peaks on the reverse scan indicate that the process is reversible. The peak heights in scan 5 are smaller than in scans 1 and 2, indicative of some electrode passivation probably due to film formation.

### Example 3

### Testing of Electrolyte Consisting of C₄C₁pyr DCA 0.5 mol/kg LiDCA 285 ppm H₂O

Lithium cycling in the electrolyte was tested using cyclic voltammetry under the conditions described above for Example 2 but with the electrolyte comprising 285 ppm H₂O.

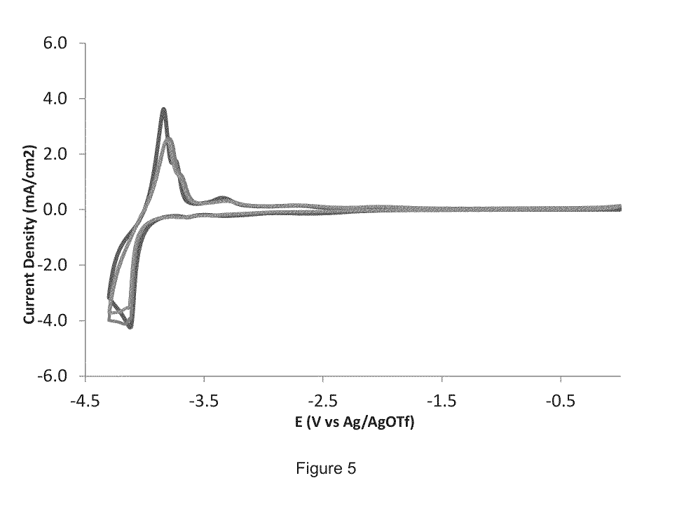

FIG. 5 shows reversible lithium deposition also occurs in this electrolyte, with the slightly higher water content (285 ppm) compared to the previous example (132 ppm). In FIG. 4 the peak currents are lower, suggesting greater passivation. Peak heights, although smaller, are somewhat more stable from cycle to cycle in this electrolyte than in the drier example.

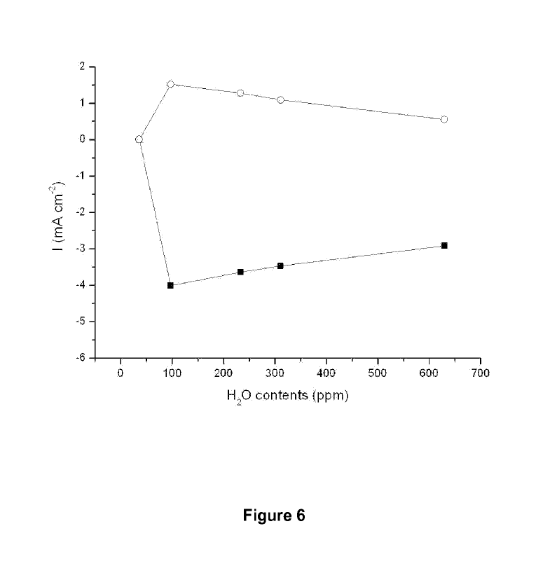

The peak currents for both the plating of Li (Li++e−→Li) and the reduction of Li (Li→Li++e−) have been plotted as a function of the moisture content in solution. Moisture contents were determined via the use of Karl-Fischer. It was found that a critical amount is required in order to maximise the plating and stripping of Li in solution as shown in FIG. 6. Of note, that when the electrolyte is at it's driest, there are no plating or stripping processes observable, whilst at higher moisture concentrations, the peak current densities reduce significantly.

### Example 4

### Testing of Electrolyte Consisting of C₄C₁pyr DCA 0.5 mol/kg LiBF₄ 296 ppm H₂O

Lithium cycling in the electrolyte was tested using cyclic voltammetry under the conditions described above for Example 2 but with the electrolyte comprising 296 ppm H₂O and 0.5 mol/kg LiBF₄ (instead of LiDCA).

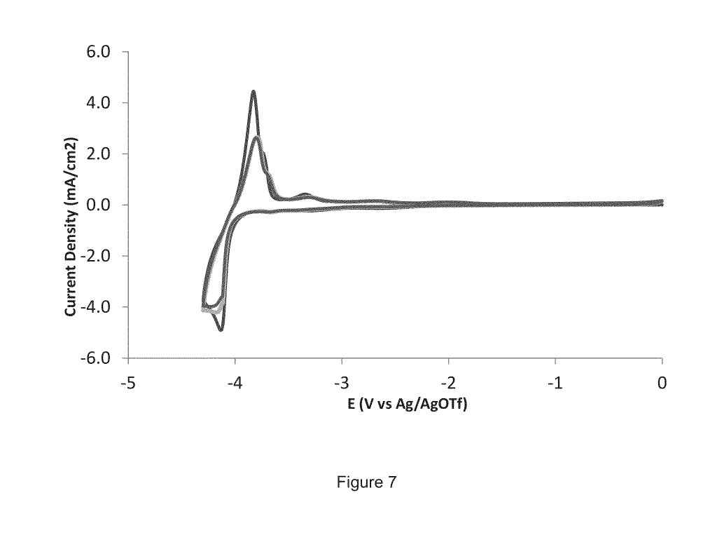

FIG. 7 shows reversible lithium deposition also occurs in the electrolyte when a lithium salt which includes a non DCA anion is used, in this case LiBF₄. Lithium cycling is clearly evident and is very similar to the all DCA system (of very similar water content) in terms of peak height and stability.

### Example 5

### Testing of the Electrolyte C₄C₁pyr DCA 0.5 mol/kg LiDCA 161 ppm H₂O in a Lithium Metal Battery Consisting of Lithium Metal Anode and LiFePO₄ (LFP) Cathode

The electrolyte C₄C₁pyr DCA 0.5 mol/kg LiDCA 161 ppm H₂O was tested in 2032 type coin cells using lithium metal as the anode material and LiFePO₄ as the cathode material. The cathode was 75% wt/wt carbon coated LFP (Phostech), 15% wt/wt carbon black (Shawinigan) and 10% wt/wt PVDF binder. In this case the loading of LFP was 3.1 mg/cm². The separator was Separion® (Evonik) of 30 micron thickness.

Charging was performed at 0.05 mA/cm² and discharging at 0.1 mA/cm², for the 3.1 mg/cm² cathode loading these current densities correspond to C/11.4 and C/5.7 respectively. The charge cut off voltage was 3.8 or 3.6 V and the discharge cut off was 3.0 V. Cells cycled at 50° C.

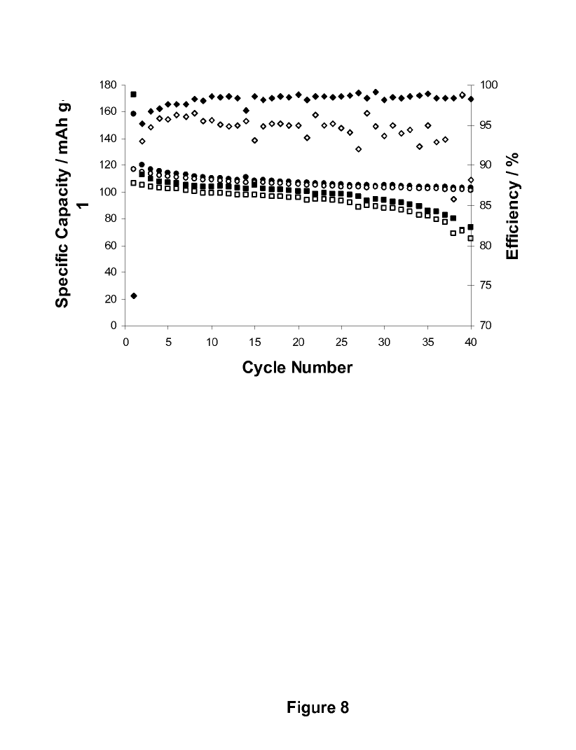

FIG. 8 shows that specific capacities of ˜115 mAh/g are achieved in initial cycling with these cells, which is moderate compared to the theoretical capacity of LFP (170 mAh/g), however there is some fade in capacity with cycle number. FIG. 8 clearly shows that 3.8 V is too high a cut-off voltage for this electrolyte, and that much less capacity fade is observed when 3.6 V limit is used. The lower cut off voltage also results in a significant improvement in cycling efficiency. Lowering the cut off voltage further may promote additional improvement.

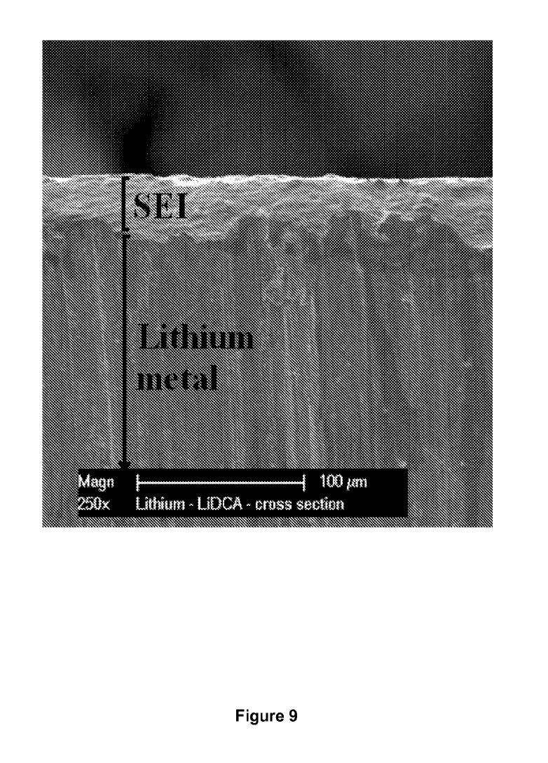

The cell was disassembled under argon atmosphere after completing 100 cycles. The cross section and surface of the lithium electrode were examined using SEM. FIG. 9 shows the cross section of the electrode. The lower portion of the figure with the vertical striations is the lithium metal, the layer of lighter material on top is the SEI.

The SEI is seen to infill all surface inhomogeneities of the lithium surface, which may have developed during lithium cycling. The top surface of the SEI is level, as it was pressed firmly against the separator in the battery. The SEI is 10-15 μm thick and appears to be a well consolidated nearly homogenous non-crystalline solid. No lithium dendrites or dead lithium are/is observed to be interdispersed in the SEI or penetrating its surface.

### Example 6

### Testing of the Electrolyte C₄C₁pyr DCA (80% mol/mol) Tetraglyme (20% mol/mol)+0.5 mol/kg LiDCA in a Lithium Metal Battery Consisting of Lithium Metal Anode and LiFePO₄ (LFP) Cathode

The electrolyte C₄C₁pyr DCA (80% mol/mol) tetraglyme (20% mol/mol)+0.5 mol/kg LiDCA was tested in 2032 coin cells, as described above, also at 50 degrees Celsius. The charging cut off voltage was 3.6 V.

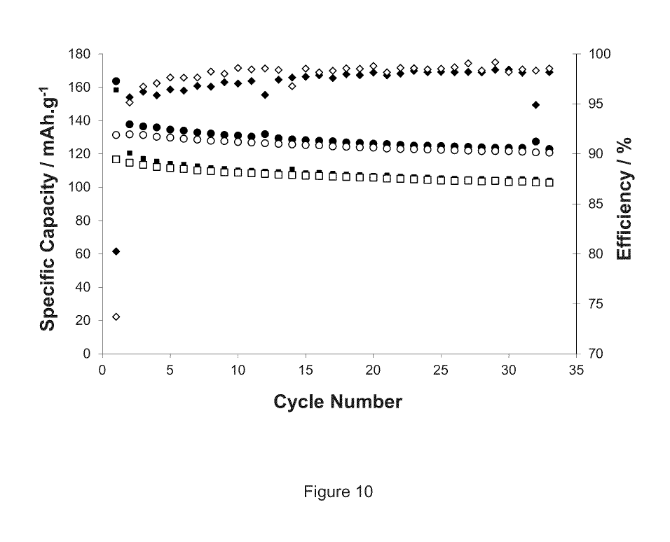

FIG. 10 shows that the use of tetraglyme at 20% mol/mol gives an improvement in specific capacity of ˜20 mAh/g or ˜17%, however it does not cause a reduction in capacity fade. Cycling efficiency is somewhat lower during initial cycling, but gradually improves to match the efficiency of the tetraglyme free case.

### Example 7

### Testing of the Electrolyte C₄C₁pyr DCA 0.45 mol/kg LiDCA 0.05 mol/kg LiBOB in a Lithium Metal Battery Consisting of Lithium Metal Anode and LiFePO₄ (LFP) Cathode

The electrolyte C₄C₁pyr DCA 0.45 mol/kg LiDCA 0.05 mol/kg LiBOB was tested in 2032 coin cells, as described above, also at 50 degrees Celsius. The charging cut off voltage was 3.8 V and the cathode loading was 2.1-2.2 mg/cm² LFP.

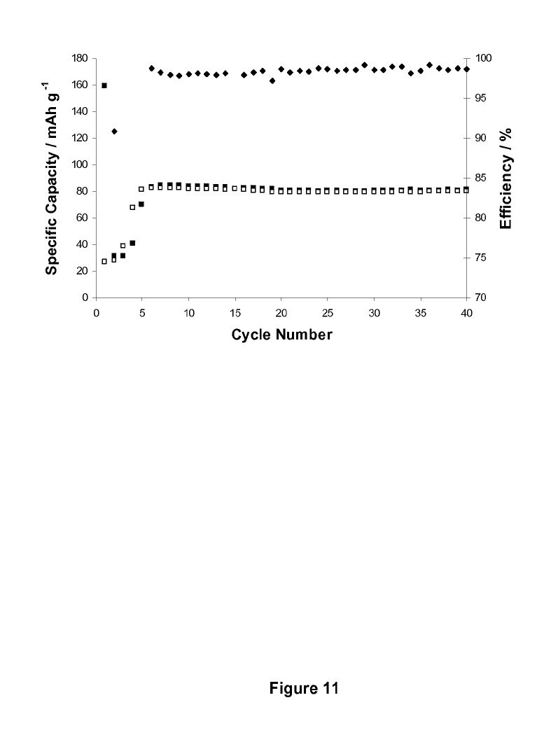

FIG. 11 shows the specific capacity performance with cycle number. Proper capacity is not reached until the 5^{th} cycle, and reaches a maximum of ˜80 mAh/g. Although the capacity is reduced compared to the BOB free case, the capacity fade is much less than in the BOB inclusive system, with no capacity fade occurring after cycle 20. Cycling efficiency is also improved somewhat in the BOB inclusive system (˜98.5%) compared to the BOB free case (˜97.5%) even though a 3.8 V cut off was used.

### Example 8

### Testing of the Electrolyte C₄C₁pyr DCA 0.5 mol/kg LiDCA in a Lithium Metal Battery Consisting of a Li₄Ti₅O₁₂ (LTO) Cathode and Lithium Metal Anode

The electrolyte C₄C₁pyr DCA 0.5 mol/kg LiDCA was tested in a 2032 coin cell consisting of a lithium metal anode, LTO cathode (loading 1.3 mg/cm2) and Separion® separator. A low LTO loading was used to ensure maximum capacity utilisation of the LTO, and hence more thorough testing of this material. Testing was at 50° C. Cycling was done at 0.1 mA/cm² for both charge and discharge, with a charge cut off voltage of 2.5 V and a discharge cut off voltage of 1.2 V.

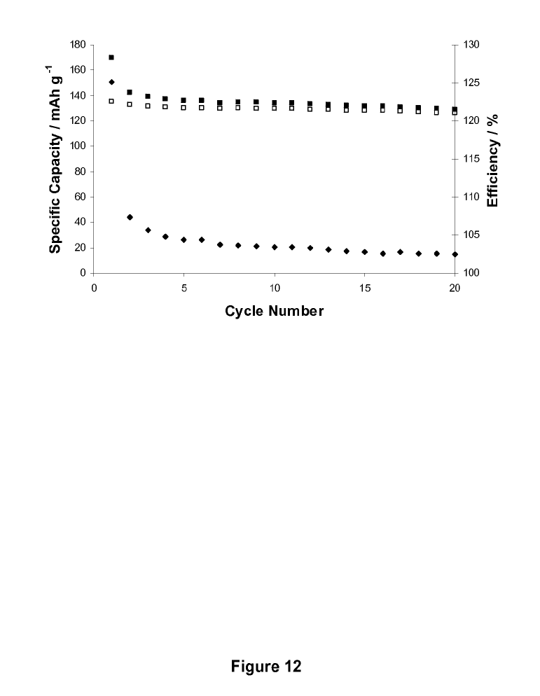

FIG. 12 shows the cell achieved a specific capacity of ˜130 mAh/g, with a slight capacity fade. Interestingly, more charge is consumed during the discharge of the cell (Li⁺ insertion into LTO, dissolution of Li metal) than during charge, leading to efficiencies of about 102%.

### Example 9

### Testing of the Electrolyte C₄C₁pyr DCA 0.5 mol/kg LiDCA in a Lithium Ion Battery Consisting of a Li₄Ti₅O₁₂ (LTO) Anode and LiFePO₄ (LFP) Cathode

The electrolyte C₄C₁pyr DCA 0.5 mol/kg LiDCA was tested in a 2032 coin cell consisting of LFP cathode (2.0 mg/cm² LFP loading) and LTO anode (2.1 mg/cm² loading) with Separion® separator. Cell charged at 0.05 mA/cm² and discharged at 0.1 mA/cm², 50° C. Cell was charged at 0.05 mA/cm² and discharged at 0.1 mA/cm². The charge cut off voltage was 2.3 V and the discharge cut off voltage was 1.5 V.

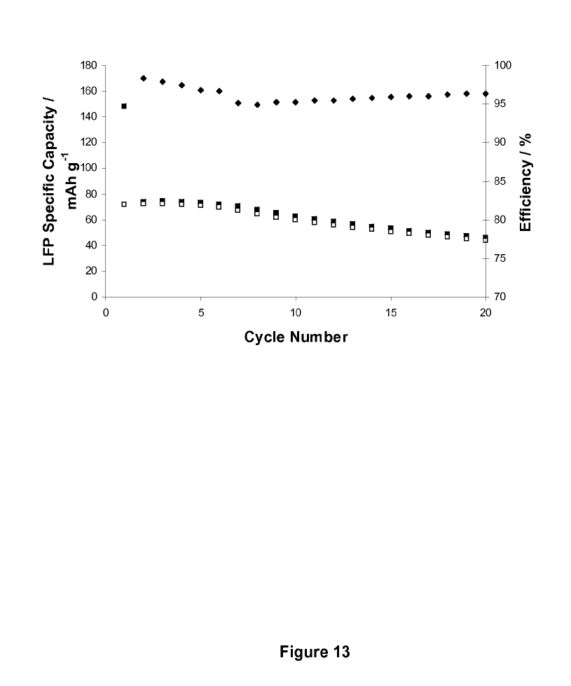

FIG. 13 shows a peak specific capacity of 80 mAh/g for this cell, and significant capacity fade. The capacity fade may be due to a high halide impurity in the C₄C₁pyr DCA (246 ppm, including 220 ppm Cl) or non-ideal electrode capacity balancing. Improvements in both should see enhancement in the capacity retention of the cell.

### Example 10

### Testing of the Electrolyte C₄C₁pyr DCA 0.5 mol/kg LiDCA 161 ppm H₂O in a Lithium Metal Battery Consisting of Lithium Metal Anode and LiFePO₄ (LFP) Cathode

A Li|LFP cell using the electrolyte C₄C₁pyr DCA 0.5 mol/kg LiDCA 161 ppm H₂O was tested with different discharge current densities to understand the affect of the discharge current density on discharge specific capacity. The charging current density was set at 0.05 mA/cm². The test temperature was 50° C. FIG. 12 shows the decline in discharge specific capacity with increasing discharge rate.

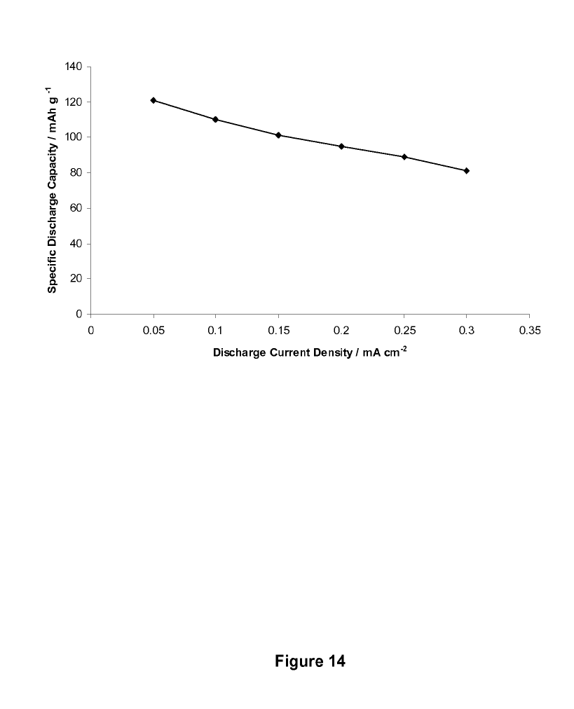

The same Li|LFP cell using the electrolyte C₄C₁pyr DCA 0.5 mol/kg LiDCA 161 ppm H₂O was tested with different charging current densities to also understand the affect of the charging current density on discharge specific capacity. The discharge current density was set at 0.05 mA/cm². The test temperature was 50° C. FIG. 14 shows the specific discharge capacity of the cell when it is charged at different rates.

1. A lithium energy storage device comprising:
at least one positive electrode;
at least one negative electrode; and,
an ionic liquid electrolyte comprising an anion, a cation counterion and lithium mobile ions, wherein the anion comprises a nitrogen, boron, phosphorous, arsenic or carbon anionic group having at least one nitrile group coordinated to the nitrogen, boron, phosphorous, arsenic or carbon atom of the anionic group.

2. The lithium energy storage device of claim 1, wherein the anion is selected from at least one of Formula Ito IV: 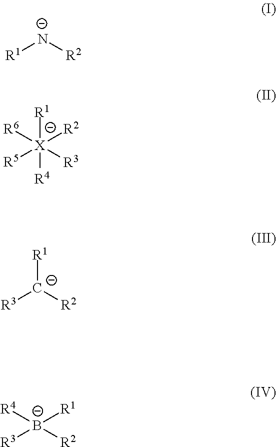
wherein
X is P or As;
R¹ is CN;
R², R³, R⁴, R⁵ and R⁶ are each independently selected from an organic group comprising a group selected from at least one of a halogen, oxalate, tosylate, ether, ester, nitrile, sulphonyl, carbonyl, and nitro group.

3. The lithium energy storage device of claim 2, wherein the organic group is independently selected from the group consisting of —CN, —F, —Cl, —(COO)₂⁻, CₘY₂ₘ₊₁SO₂—, CₘY₂ₘ₊₁SO₃—, CₘY₂ₘ₊₁C₆Y₄SO₂—, CₘY₂ₘ₊₁C₆Y₄SO₃—, R⁷—SO₂—, R⁷—SO₃—, CₘY₂ₘ₊₁C(O)O—, CₘY₂ₘ₊₁O(O)C—, CₘY₂ₘ₊₁CY₂O—, CY₃O—, CₘY₂ₘ₊₁OCY₂—, —C₂₋₆alkenyl; wherein Y is F or H, m is an integer of 1 to 6, and R⁷ is a halogen.

4. The lithium energy storage device of claim 2, wherein at least one of R₂ to R₆ are —CN.

5. The lithium energy storage device of claim 1, wherein the anion is selected from the group consisting of ⁻P(CN)₆, ⁻As(CN)₆, ⁻N(CN)₂, ⁻C(CN)₃ and ⁻B(CN)₄.

6. The lithium energy storage device of claim 5, wherein the anion is ⁻N(CN)₂.

7. The lithium energy storage device of claim 1, wherein the ionic liquid electrolyte is substantially free of halide ions, or the ionic liquid electrolyte is substantially free of fluoride ions.

8. The lithium energy storage device of claim 1, wherein the lithium mobile ions are provided by one or more lithium salts selected from the group consisting of LiDCA, LiBF₄, LiBOB, LiTFSI, LiFSI, and LiPF₆.

9. The lithium energy storage device of claim 8, wherein the amount of lithium salt is between 0.3 to 1.0 mol/kg, between 0.4 to 0.6 mol/kg, or about 0.5 mol/kg.

10. The lithium energy storage device of claim 1, wherein the cation counterion is selected from the group consisting of pyrrolidiniums, piperaziniums, piperidiniums, di- or tri-substituted imidazoliums and the phosphorous and arsenic derivatives thereof, 1,1-dialkyl-pyrrolidinium, N-butyl-N-methyl-pyrrolidinium.

11. The lithium energy storage device of claim 1, wherein the at least one positive electrode comprises a lithium oxide material selected from the group consisting of LiCoO₂, LiMnO₂, LiMn₂O₄, LiMnO₂, LiNiMnCrO₂, LiMnNiO₄, and analogues thereof, conducting polymers, redox conducting polymers, and combinations thereof.

12. The lithium energy storage device of claim 1, wherein the at least one positive electrode comprises a lithium metal phosphate, such as LiFePO₄.

13. The lithium energy storage device of claim 1, wherein the at least one negative electrode comprises a lithium titanium oxide material, such as Li₄Ti₅O₁₂.

14. The lithium energy storage device of claim 1, wherein the ionic liquid electrolyte comprises one or more additional components selected from the group consisting of a room temperature ionic liquid, diluent, solid electrolyte interphase-forming (SEI) additive, gelling additive, and organic solvent, and wherein the SEI forming additive is selected from the group consisting of: polymers, including the electroconductive polymers, such as polyvinylpyrrolidone, polyethylene oxide, polyacrylonitrile, polyethylene glycols, the glymes, such as tetraglyme, perfluorinated polymers; and salts, such as magnesium iodide, aluminium iodide, tin iodide, lithium iodide, tetraethylammonium heptadecafluorooctanesulfonate, dilithiumpthalocyanine, lithium heptadecafluorooctanesulfonate, tetraethylammonium fluoride-tetrakis hydrogen fluoride.

15. The lithium energy storage device of claim 1, wherein the electrolyte comprises water in an amount of 50 to 500 ppm, 100 and 300 ppm, or about 200 ppm.

16. The lithium energy storage device of claim 1, wherein the lithium energy storage device is operable over a temperature range of 0 to 80° C.

17. The lithium energy storage device of claim 1, wherein the device is a lithium metal energy storage device and the at least one negative electrode is a lithium metal negative electrode.

18. The lithium energy storage device of claim 1, wherein the device is a lithium ion energy storage device and the at least one negative electrode comprises lithium titanium oxide, such as LiTi₅O₁₂.

19. The lithium energy storage device of claim 1, wherein the ionic liquid electrolyte comprises a dicyanamide anion.

20. A method of charging the lithium energy storage device of claim 1, comprising the step of charging the device at a charge voltage of less than 3.8 V.
